(19) United States
(12) Patent Application Publication
(10) Pub. No.: US 2018/0343971 A1
(43) Pub. Date: Dec. 6, 2018

(54) VENOUS THROMBOEMBOLISM PREVENTION FOOTWEAR

(71) Applicants: Rakesh Kumar AGGARWAL, Docklands, Victoria 3008 (AU); Dinesh AGARWAL, Brighton, Victoria 3186 (AU)

(72) Inventors: Rakesh Kumar AGGARWAL, Docklands, Victoria 3008 (AU); Dinesh AGARWAL, Brighton, Victoria 3186 (AU)

(21) Appl. No.: 15/781,245

(22) PCT Filed: Jan. 4, 2017
(86) PCT No.: PCT/AU2017/050006

§ 371 Date: Jun. 4, 2018

(30) Foreign Application Priority Data
Jan. 12, 2016 (AU) 2016900089

(51) Int. Cl. A43B 13/20; A43B 3/00; A43B 17/03; A43B 7/14; A61H 9/00

(52) U.S. Cl. CPC A43B 13/203; A43B 3/0005; A43B 17/035; A43B 17/026; A61H 9/0078; A43B 7/147; A43B 7/146

(57) ABSTRACT

The invention provides an apparatus and method for the prevention of VTE and related conditions to promote blood flow in a foot, the apparatus including: at least two inflatable bladders (20, 21) adapted to be disposed in use under the foot; and one or more pumps (31, 32) configured to repeatedly inflate and deflate the bladders with a fluid, applying compressive force to the foot in use.

### FIELD

The present invention relates to an apparatus and method for the prevention of venous thromboembolism, including deep vein thrombosis.

### BACKGROUND

Venous thromboembolism (VTE) is a disease that includes deep vein thrombosis (DVT) and pulmonary embolism (PE). DVT and PE are both forms of VTE, but they are not the same thing.

Related conditions include chronic venous insufficiency (CVI) and peripheral arterial disease (PAD). CVI of the lower extremities is a condition caused by abnormalities of the venous wall and valves that leads to obstruction or reflux of blood flow in the veins. Peripheral artery disease is a disease in which plaque builds up in the arteries which carry blood to the head, organs, and limbs.

Deep vein thrombosis, or deep venous thrombosis (DVT) is the formation of a blood clot (thrombus) within a deep vein, predominantly in the legs. Non-specific signs may include pain, swelling, redness, warmness, and engorged superficial veins. Pulmonary embolism, a potentially life-threatening complication, is caused by the detachment (embolisation)) of a clot which travels to the lungs. Together, DVT and pulmonary embolism constitute a single disease process known as venous thromboembolism (VTE).

Normally, oxygenated blood is pumped by a person's heart through the arterial system into the lower limbs and the feet, like any other part of body. The deoxygenated blood is returned to the heart through veins against gravity. Veins have valves to prevent reverse flow of the blood against gravity. Lower limbs have a system of superficial and deep veins connecting foot veins and calf veins. In an upright posture the venous blood pressure near the heart is close to zero. The vein pressure of the feet in a horizontal position is approximately 5 mmHg, increasing to 70-80 mmHg in an upright position. At passive sitting, the pressure is in the order of 45-60 mmHg, determined by the height of the blood column from the feet to the heart.

The energy needed for venous blood to overcome the hydrostatic pressure, which is generated by the distance between the heart and the leg in standing subjects in a dynamic state, is created by multiple myofascial compartments that are separate yet integrated, act like muscle pump units, and are known as the venomuscular pumps (OMP). Of interest are three pumps: the venous foot pump; the distal calf pump; and the proximal calf pump. During normal walking, the three vein-pumping system (foot pump, proximal calf pump, and distal calf pump) are synchronised to form a complete network both in series and in parallel, which promote venous return.

The venous pump system normally reduces dorsal foot vein pressure from approximately 70-80 mmHg at the passive upright position to 25-30 mmHg during ambulation.

Prolonged inactivity may cause venous stasis in the leg veins and may lead to the clotting of blood of deep vein thrombosis (DVT). DVT may be life-threatening if clots move to lungs from lower limbs causing embolism. Venous thrombosis, including DVT and PE, occurs at an annual incidence of about 1 per 1000 adults. Rates increase sharply after around age 45 years, and are slightly higher in men than women in older age. Major risk factors for thrombosis, other than age, include exogenous factors such as surgery, hospitalization, immobility, trauma, pregnancy and the puerperium and hormone use, and endogenous factors such as cancer, obesity, and inherited and acquired disorders of hypercoagulation. The risk of VTE may persist up to 3 months following major orthopaedic surgery.

Prevention of VTE in high risk surgical patients is achieved by combination of pharmacological agents and various mechanical devices. Compression devices for applying compressive forces or intermittent impulse compression to a selected area of a wearer's anatomy are generally employed to improve blood flow in the selected area.

Graduated compression stockings are the only practical mechanical device available for ambulatory patients for prevention of DVT. These stocking provide constant compression of the lower limb. They may become uncomfortable after some time and are not liked by many patients. They may be difficult to put on and may require some assistance.

Foot compression has become a popular alternative for prevention of DVT. There is good recent evidence that foot compression is haemodynamically effective, typically showing doubling of peak velocities on compression compared with resting, with some small differences between systems. Foot compression, however, needs significantly higher pressures than calf compression, typically 130 mm Hg or more, compared with 40 mm Hg in the calf, there being a small amount of blood in the plantar venous plexus: about 20 mL to 30 mL, compared with 100-150 mL in the calf, and the muscles are less readily compressible.

Compression devices which provide intermittent pulses of a compressed fluid such as air to inflate at least one inflatable chamber on specified parts of anatomy are particularly useful. This cyclic application of pressure provides a non-invasive prophylaxis to reduce the incidence of deep vein thrombosis (DVT). These compression devices find particular use during surgery or long periods of immobility on patients with high-risk conditions such as obesity, advanced age, malignancy, or prior thromboembolism. Patients who develop this condition often have swelling (oedema) and tissue breakdown (venous stasis ulcer) in the lower leg. When a DVT occurs, the valves that are located within the veins of the leg can be damaged, which in turn can cause stasis and high pressure in the veins of the lower leg.

Generally, these compression devices are fluidly coupled to a source of pressurized fluid. Additionally, each compression device includes a flexible shell having one or more bladders disposed therein. The compression device is placed around the patient's foot or other selected portion whereupon a pressurized fluid is delivered into the bladder creating pressure at the part or parts of the body in contact with the bladder.

Wide consensus exists in the literature that compression is a necessary part of all treatments for CVI and venous ulcers. Often patients do not comply with compression therapies, such as stockings, bandages, and Unna's boot, because of difficulty with use of the therapies. Long-term use of pneumatic compression devices in the home environment may be an alternative to other compression therapies for patients who are unable or refuse to comply with other methods. In one study, home use of impulse compression foot and compression stockings were found effective in the treatment of chronic venous insufficiency.

Mechanical devices may also include graduated compression stockings and intermittent pneumatic compression (IPC) devices. IPC is usually applied to the calf muscles or to the calf muscles and foot in combination. An example of such a device is disclosed in U.S. Pat. No. 9,168,197 B2, in which a foot cuff or leg sleeve is has a controller which controls a pressuriser which in turn executes cyclic compression cycles for applying intermittent compression therapy to the foot or limb. Recently, intermittent pneumatic compression of the foot has become popular for prevention of VTE in orthopaedic patients. One example of a compressive foot cuff is described in U.S. Pat. No. 8,636,678 B2, which facilitates the cyclic application of pressure.

IPC devices use a heavy motor which is attached to the cuff applied around the calf or the foot. These devices can only be used in patients during surgical procedures and after the surgical procedures when patients are confined to the bed while recovering. This is also the case with the cumbersome arrangement where an item of footwear for applying dynamic compression to a person's foot is connected by a conduit to a fluid generator for supply of fluid. One example of such an arrangement is disclosed in U.S. Pat. No. 5,931,797.

Any type of travel has the potential to increase the risk of venous thromboembolism: the duration of travel is a key factor. Travel by air, car, train or bus for four or more hours all increases the risk about twofold for several weeks after travel. There also appears to be an association between long haul flights and VTE. The incidence of lower limb venous thrombosis in low risk passengers is about 1.6% while in those with additional risk factors is about 5%.

About two-thirds of episodes manifest as DVT and one-third as PE with or without DVT. The major outcomes of venous thrombosis are death, recurrence, post-thrombotic syndrome and major bleeding due to anticoagulation. Thrombosis is also associated with impaired quality of life, particularly when post-thrombotic syndrome develops. Death occurs within one month of an episode in about 6% of those with DVT and 10% of those with PE. The mortality rate for PE has been estimated to be high as 30% in studies that included autopsy-based PE diagnosis, pointing out the fact that many PE are not recognized clinically before death.

Qantas Airways Limited recommends on its website light exercises for its passengers, which it states: “may be effective at increasing the body's blood circulation”. The exercises include ankle circles, foot pumps, knee lifts, neck rolls and “knee to chest”. Apart from such exercises, the only other DVT-prevention course of action is to wear compression stockings.

There have been suggested self-contained items of footwear which apply dynamic compression to the foot of the wearer, for DVT reduction. U.S. Pat. No. 7,909,783 B2 and U.S. Pat. No. 8,246,556 described variations on an invention which relates to a mechanical system utilising a pressure pad which provides a compressive force to the venous plexus region of the foot. In the latter document, the pressure pad is successively withdrawn and re-pressed against the foot.

US 2011/0214315 A1 discloses a therapy shoe which has a therapy device located in a housing beneath the insole of the shoe, which therapy device provides a compressive force to the venous plexus region of the foot inserted into the shoe. The therapy device is exemplified by the mechanical pressure device disclosed in U.S. Pat. No. 7,909,783.

In CA 2 350 045 A1, there is disclosed an electrical leg-massaging device which may be used in-flight to mechanically and passively stimulate blood circulation in the legs. The device is intended to be worn around the calf of a passenger.

Another device for DVT prevention in a long distance traveller is described in US 2007/0238587. In that document, a sole plate is adapted to be worm beneath the stockinged foot or shoe of a passenger. The sole plate has rolling means to afford both linear and rotational motion of the plate when worn, thus preventing DVT and possible pulmonary embolism.

EP 2 898 789 discloses an actuator located in the heel of a shoe, which is connected to a movement transmission means, which in turn is connected to a pad. When a person wearing the shoe takes a step, and the heel strikes the ground, it causes the actuator to move the pad to briefly apply pressure to the plantar venous pump.

GB 2488232 A describes a shoe or similar footwear intended for sufferers of diabetes. The show has a fluid pump located in the heel of the shoe, which communicates with a reservoir, which in turn is connected to a plantar plexus stimulating section. As a wearer of the show walks, the heel striking the ground activates the heel pump to force fluid into the reservoir. This may be augmented by a battery-powered pump. Control means controls the fluid flow from the reservoir to the plantar plexus stimulating section, for a brief stimulation to urge movement of the sub-dermal veins in the plantar plexus region.

There is a need for an unobtrusive shoe device with improved promotion of blood flow adapted for use in an aircraft environment.

### SUMMARY OF THE INVENTION

The invention may provide, in a first broad aspect, an apparatus for the prevention of VTE and related conditions to promote blood flow in a foot, the apparatus including:

at least two inflatable bladders adapted to be disposed in use under the foot; and

one or more pumps configured to repeatedly inflate and deflate the bladders with a fluid, applying compressive force to the foot in use.

In one embodiment, the at least two inflatable bladders comprise a first inflatable bladder adapted to be disposed in use beneath a forefoot of the foot, and a second inflatable bladder adapted to be disposed in use beneath a midfoot of the foot.

In one embodiment, the fluid is atmospheric air.

In one embodiment, the apparatus further comprises a microcontroller configured to provide the repeated inflation and deflation of the bladders.

In one embodiment, the repeated inflation and deflation of the bladders is configured to provide a compressive wave from the forefoot to the midfoot.

In one embodiment, the repeated inflation and deflation of the bladders comprises cycles, each cycle comprising an inflation of the first inflatable bladder, followed by inflation of the second inflatable bladder, followed by deflation of the first and the second inflatable bladders.

In one embodiment, the apparatus is provided in a cavity in a sole of a shoe.

In one embodiment, the apparatus is provided in an insert insertable above a sole of a shoe.

In accordance with a second broad aspect of the invention there may be provided a method of preventing VTE and related conditions by promoting blood flow in a foot, the method comprising the steps of:

providing at least two inflatable bladders adapted to be disposed in use under the foot;

providing one or more pumps;

configuring the one or more pumps to repeatedly inflate and deflate the bladders with a fluid, applying compressive force to the foot in use.

### BRIEF DESCRIPTION OF DRAWINGS

FIG. 1 is a semitransparent plan view of a shoe comprising an apparatus according to an embodiment of the invention;

FIG. 2 is a perspective view of a sole of the shoe of FIG. 1 showing cavities accommodating elements of the apparatus of the embodiment of FIG. 1;

FIG. 3 is a diagram of inflatable bladders according to the embodiment of FIG. 1; and

FIG. 4 is a functional diagram of components of the apparatus of the embodiment of FIG. 1.

### DETAILED DESCRIPTION OF EMBODIMENTS

An embodiment of the current invention will now be described.

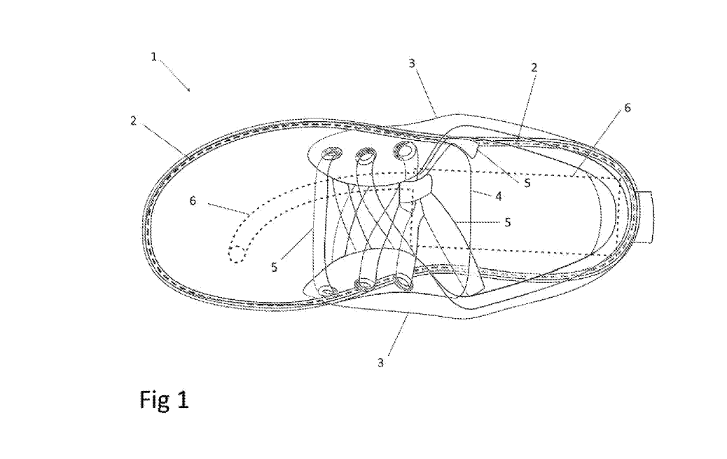

Referring first to FIG. 1, a semitransparent plan view is provided of an embodiment of the invention. Shoe 1 is defined by sole perimeter stitching 2 affixing leather or fabric upper 3 including tongue 4, and shoelace 5. Control elements of apparatus of the invention are positioned in the sole of the shoe within a cavity defined by dotted line 6 comprising a rectangular cavity and a channel.

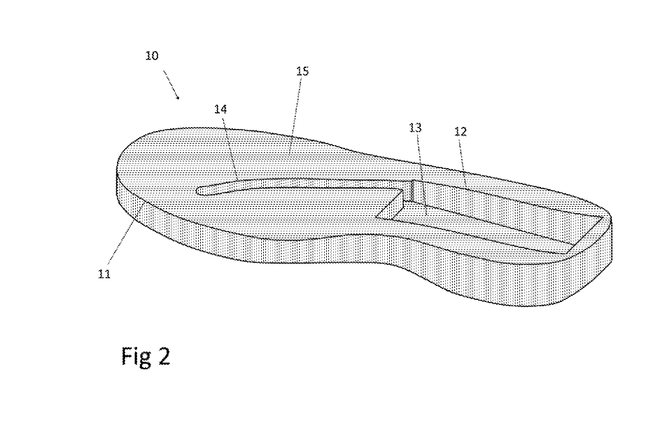

Referring now to FIG. 2, a perspective view shows sole 10 composed of a block of EVA, defining sole upper surface 15, perimeter 11, control box rectangular cavity defined by recessed floor 13 about 20 millimetres below sole upper surface 15, and control box rectangular cavity perimeter 12 of dimensions approximately 120 by 45 millimetres. Leading from perimeter 12 is a channel 14 of width approximately 6 millimetres and depth of approximately 6 millimetres for accommodating of a first inflation tube for connecting with a first inflatable bladder positioned under a forefoot of the wearer, as described in more detail below.

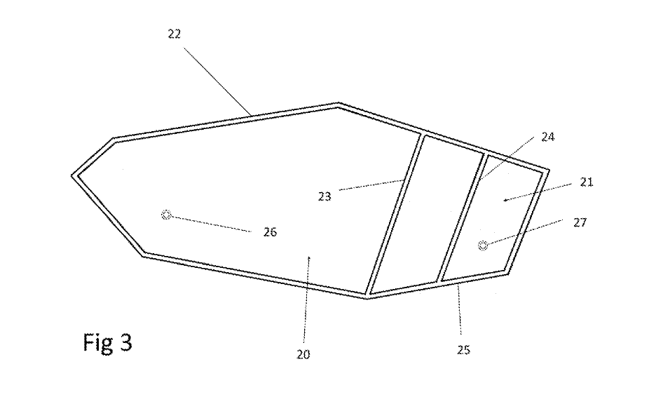

Referring now to FIG. 3, the inflatable bladders of the embodiment are shown, from below. The inflatable bladders are constructed from a double layer of polyurethane thermoplastic elastomer (TPU-70), sealed around perimeters by heat seal lines such as 22, 23, 24, 25 and incorporating annular pneumatic tube attachment elements 26, 27 comprising annular projections of outside diameter 5 mm and inside diameter 3 mm adapted for attaching and securing to correspondingly sized first and second inflation tubes of plastic by friction fit. First inflatable bladder 21 is defined by perimeter elements 24, 25 and attachment element 27, and is shaped and positioned to inflate beneath a forefoot of the wearer, at the base of the toes. Attachment element 27 is positioned to correspond with an end of channel 14 engaging with first inflation tube. Second inflatable bladder 20 is defined by perimeter elements 22, 23 and attachment elements 26, and is shaped and positioned to inflate beneath a midfoot of the wearer at the arch. Attachment element 26 is positioned to correspond with and protect into an aperture in a top of the control box when positioned in rectangular cavity defined by perimeter 12, to attach to a shorter second inflation tube disposed within the control box.

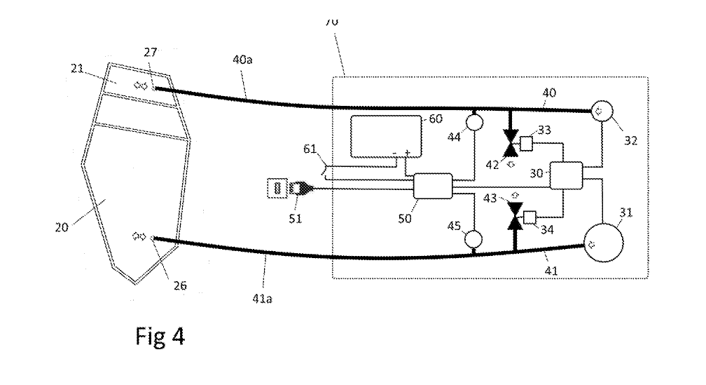

Referring now to FIG. 4, a functional diagram of the components of the apparatus is shown. The diagram is not to scale and is drawn for explanatory clarity. Pneumatic lines are depicted by heavy solid black lines such as 40, 40a, 41, 41a, and the direction of inflation and deflation air is depicted by hollow arrows.

Control box 70 is shown as a dotted line and is sized to fit within perimeter 12 of sole 10, and a rectangular memory foam spacer shaped to correspond with perimeter 12 placed above control box 70. Bladders 20, 21 are disposed above as described above. In relation to second inflation bladder 20, second inflation tube 41a in reality is short and inside control box 20, with attachment elements 26 projecting into an aperture in a lid of control box 20 as described above. A layer of padded fabric as an insole is then disposed above bladders 20, 21.

Two other elements project from control box 70 and are not specifically depicted in the diagrams FIG. 1-3. These are isolation switch 61 and USB charging port 51. Isolation switch 61 is an on off switch for isolating and connecting lithium ion rechargeable battery 60. USB charging port 51 enables recharging of rechargeable battery 60 and may also facilitate communication with BLE controller 50 for programming or user interaction, in addition to the Bluetooth communication channel. USB charging port 51 is connectable by the wearer to a USB charging cable conveniently able to be connected to airline seat electronic device USB charging sockets or mobile phone chargers. Isolation switch 61 and USB charging port 51 are typically provided on the end of a cable leading from control box 70 and along shoe upper 3 to a convenient location on the shoe sufficiently elevated to be substantially protected from water ingress caused by walking on wet ground, and operable by the wearer while wearing shoe 1.

Bluetooth low-energy (BLE) controller 50 (obtainable as an off-the-shelf item) contains a programmed microprocessor and input output components and is the primary controller of the system. BLE controller 50 controls management of lithium ion rechargeable battery 60 (3.7 volt, 1600 mAh), including charging through USB charging port 51. User controls for the system are provided by Bluetooth communication with BLE controller 50 through an app operable from a smartphone or tablet device. BLE controller also measures pressure in pneumatic lines 40, 41 through pressure transducers 44, 45 and actuates pumps 31, 32 and solenoid release valves 33, 34 through motor controller 30 (obtainable as an off-the-shelf item). First pump 32 pressurises first inflation line 40 through inflation tube 40a to inflate first bladder 21. First pump 32 is stopped when pressure transducer 44 reaches a desired inflation pressure. Pressure transducer 44 Solenoid valve 42 controlled by solenoid 33 is normally closed and when solenoid 33 is energised, air escapes from and depressurises first inflation line 40, deflating first bladder 21. Similarly, second pump 31 pressurises second inflation line 41 through inflation tube 41a to inflate second bladder 20. Second pump 31 is stopped when pressure transducer 45 reaches a desired inflation pressure. Solenoid valve 43 controlled by solenoid 34 is normally closed and when solenoid 34 is energised, air escapes from and depressurises second inflation line 41, deflating second bladder 22.

The system through BLE controller 50 is programmed to provide a repeated inflation and deflation of first inflation bladder 21 and second inflation bladder 20. The repeated inflation and deflation is co-ordinated to provide a wave of compression from the forefoot through the midfoot, enhancing venous return from the foot compared with single arch inflation bladders.

An example of the coordination cycle is as follows. At the start of the cycle, first inflation bladder 21 is inflated to 130 mmHg. Three seconds later, second inflation bladder 20 is also inflated to 130 mmHg, creating a wave of compression from the forefoot to the midfoot. After a further three seconds following full inflation, both first and second inflation bladders 20, 21 are deflated. The cycle is repeated at an interval of 40 seconds.

It has been found that when fully charged, the system can operate continuously for eight hours or more.

It is advantageous to program system to sense when the wearer stands up and starts walking, whereby the first and second inflation bladders 21, 20 are deflated and the cycle paused. This may be detected by an accelerometer chip, or by increase or fluctuation in pressure sensed by pressure transducers 44, 45.

It is believed that the provision of two inflation bladders preferably operable in sequence, particularly with a forefoot inflation bladder inflated before the midfoot function bladder, improved venous return is enabled. Furthermore, fitting the controls and other components inside a sole of the shoe enables an unobtrusive system which is suitable for in-flight use.

The following results were obtained in an experiment on a human subject using above embodiment of the invention:

| | | Shoe in operation |
|---|---|---|
| | Foot at | (average of 5 |
| | rest | readings) |
| Peak blood velocity | 7.6 | 18.3 |
| cm/s | | |
| Mean blood velocity | 1.6 | 8.0 |
| cm/s | | |
| Volume flow ml/min | 68.3 | 327 |

Persons skilled in the art will also appreciate that many variations may be made to the invention without departing from the scope of the invention, which is determined from the broadest scope and claims.

For example, while the embodiment described utilises atmospheric air as the inflation fluid, a liquid could also be used in devices suitably designed to contain the fluid in reservoir when deflated.

Further, while the embodiment described utilises space within a sole of a shoe, other embodiments are envisaged involving an insert which may be inserted inside a shoe on top of the sole. In such an insert embodiment, the isolation switch and USB power terminal may be provided in the insert and operable when the wearer removes the insert.

Further still, while the embodiment described describes the first inflation bladder disposed beneath the forefoot and a second inflation bladder disposed beneath the midfoot, timed for inflation in a sequence of forefoot before midfoot, other locations of the at least two inflation bladders and different timing coordinations thereof are within the broadest scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

It is to be understood that, if any prior art publication is referred to herein, such reference does not constitute an admission that the publication forms a part of the common general knowledge in the art, in Australia or any other country.

1. An apparatus for the prevention of VTE and related conditions to promote blood flow in a foot, the apparatus comprising:
at least two inflatable bladders adapted to be disposed in use under the foot; and
one or more pumps configured to repeatedly inflate and deflate the bladders with a fluid, applying compressive force to the foot in use.

2. The apparatus of claim 1, wherein the at least two inflatable bladders comprise a first inflatable bladder adapted to be disposed in use beneath a forefoot of the foot, and a second inflatable bladder adapted to be disposed in use beneath a midfoot of the foot.

3. The apparatus of claim 1, wherein the fluid is atmospheric air.

4. The apparatus of claim 1, further comprising a microcontroller configured to provide the repeated inflation and deflation of the bladders.

5. The apparatus of claim 2, wherein the repeated inflation and deflation of the bladders is configured to provide a compressive wave from the forefoot to the midfoot.

6. The apparatus of claim 5, wherein the repeated inflation and deflation of the bladders comprises cycles, each cycle comprising an inflation of the first inflatable bladder, followed by inflation of the second inflatable bladder, followed by deflation of the first and the second inflatable bladders.

7. The apparatus of any one of claim 1, wherein the at least two inflatable bladders are within a cavity in a sole of a shoe.

8. The apparatus of claim 1, wherein the at least two inflatable bladders are in an insert that is insertable above a sole of a shoe.

9. A method of preventing VTE and related conditions by promoting blood flow in a foot, the method comprising the steps of:
providing at least two inflatable bladders adapted to be disposed in use under the foot;
providing one or more pumps; and
configuring the one or more pumps to repeatedly inflate and deflate the bladders with a fluid, applying compressive force to the foot in use.
